(19) United States
(12) Patent Application Publication
(10) Pub. No.: US 2007/0014298 A1
(43) Pub. Date: Jan. 18, 2007

(54) Providing quick response to events in interactive audio

(76) Inventor: Richard Welcher Bloomstein, Highland Park, IL (US)

Correspondence Address: RICHARD W. BLOOMSTEIN, 1443 CAVELL STREET, HIGHLAND PARK, IL, 60035-2807, US

(21) Appl. No.: 11/482,260

(22) Filed: Jul. 7, 2006

Related U.S. Application Data
(60) Provisional application No. 60/699,324, filed on Jul. 15, 2005.

(51) Int. Cl. H04L 12/56

(52) U.S. Cl. 370/395.64

(57) ABSTRACT

A method providing quick and appropriate audio response to events such as mouse movements on a web page in a network like the Internet. In the known art audio responses, such as vocal descriptions are annoying and confusing because they take several seconds before being heard. The described method overcomes this confusion by initiating, typically, two instances of an audio player in the viewer's browser. One instance plays a quick response file such as a MIDI lead-in file while the other plays the slower initiating voice description. The result is immediately responsive and appropriate.

### CROSS-REFERENCE TO RELATED APPLICATIONS

This application claims the benefit of provisional application 60/699,324 dated Jul. 15, 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to a technique, specifically apparatus and accompanying method for providing quick and appropriate audio responses to operator actions in an interactive network such as the Internet.

It is at times useful to provide a response to events, such as mouse movements, in an interactive network such as the Internet. For example, the U.S. Patent Office's current home page, like that of many web pages, visually changes the color of and underlines key phrases as a viewer's mouse rolls over the “hot spots”. My experiments have shown that it is also useful at times to provide a voice response to such mouse movements. For example, instead of visual changes, a voice can provide a brief description or narrative of the page that would be loaded if the viewer clicked the “hot spot”.

Currently, providing useful voice descriptions on the Internet face response time problems. The ability to digitize, compress, transmit, and play voice descriptions in response to viewer's mouse movements are known. The response time problems occur particularly at the common (56 kb) dial up connections. Even the most advanced voice compression and streaming audio techniques typically require a six second delay before the voice sound begins. Frequently the mouse moves on to a second hot spot before any audible response is heard triggered by the first. My experiments have shown this is confusing and annoying.

My experiments have also shown that pre-loading voice data is not a practical alternative because of the long time needed to pre-load the large amount of data necessary and by the unpredictability of viewers' mouse movements.

The current invention reduces the apparent response time by playing a quick response file in addition to the narrative response appropriate to the event.

### BRIEF SUMMARY OF THE INVENTION

The invention provides a quick and appropriate audio response such as a vocal description to events such as mouse movements in a network like the Internet. In the known art audio responses may take several seconds before they are heard. The delay can be confusing. The present invention overcomes this confusion by initiating, typically, two instances of an audio player. One plays a quick response file such as a MIDI file while the other plays the slower initiating voice description.

### BRIEF SUMMARY OF THE SEVERAL VIEWS OF THE DRAWING

FIG. 1 illustrates a typical embodiment of the invention. It shows a server computer (1) connected to a network (5) such as the Internet. The server computer sends coded web pages (2) and audio files (3,4) to a remote computer (6) where they are played under the control of the code in a web page (2) by media player programs (12) operating within a browser program (11).

### DETAILED DESCRIPTION OF THE INVENTION

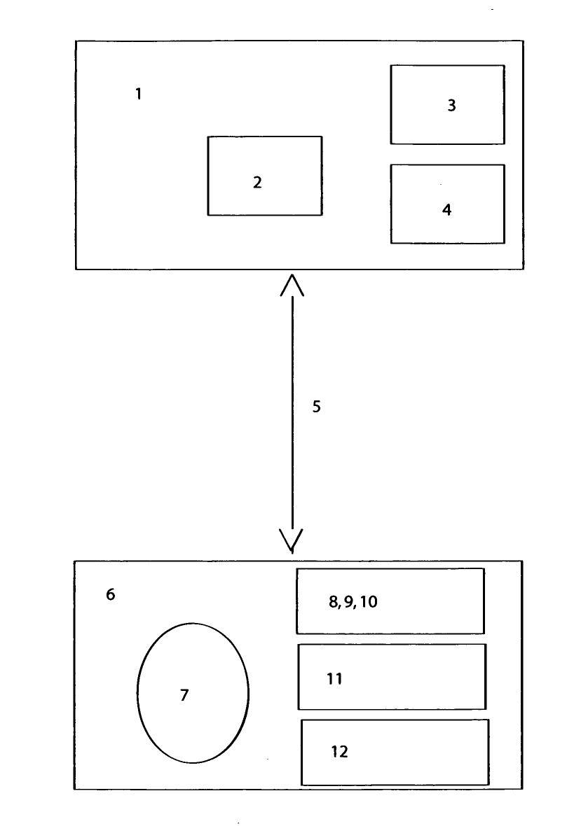

The process is illustrated in FIG. 1. A server computer (1) includes coded web pages (2), narrative voice files (3) related to individual “hot spots” on web pages, and quick response audio files (4) such as music or voice typically related to a group of “hot spots”.

The server (1) computer is located on a network (5) such as the Internet, connecting the server to a remote computer (6).

The typical remote computer (6) includes a person (7), a monitor (8), a mouse (9), and a speaker (10). The remote computer (6) operates under control of a browser program (11) such as the Microsoft Internet explorer. The browser program (11) a media player program (12) such as the Microsoft Windows Media Player.

The server computer (1) transmits a coded web page (2) to the remote computer (6) which displays text and graphics on the monitor (8).

A person (7) moves the mouse (8) in response to the display.

Code, contained in the web page (2), responds to movement of the mouse (9) rolling over “hot spots” on the web page. The code, operating through the browser (11) sends requests via the network (5) to the server (1) to transmit narrative voice (3) and quick response (4) files. The code also directs the media player program (12) to play the narrative voice (3) and quick response (4) files through the speaker (10).

The underlying problem is the delay between the trigger event, like the mouse movement over a “hot spot” and the beginning of any audible response. The delay is due to the large amount of data even in compressed voice and the need of audio players in the viewer's computer to load a sufficient buffer to guarantee unbroken playing in an Internet web page. By contrast, no appreciable delay is encountered in transmitting and playing music in note oriented form such as music in the MIDI format.

In the preferred embodiment, code in the web page is sent to the viewer's computer. The code is executed when loaded into the browser program. The code requests the browser create instances of two separate copies of media player software: one copy for quick response, such as a MIDI music file, and one for narrative voice files. Additional code accompanying the web page is executed upon the occurrence of an event such as the movement of the mouse over a “hot spot”. In the preferred embodiment, the code instructs the viewer's browser program to load and play a quick response file in one instance of a media player and a narrative voice file in a second instance. computer both players are simultaneously triggered by the same event such as mouse movement over a hot spot. The MIDI music, which can be written to require very little data, plays almost immediately. The voice may start to play six seconds later.

Music pieces can be composed and transcribed in MIDI format in such a way that they can accompany voice in a pleasant manner both as lead-in and as background. In the preferred method such music is used to automatically adjust response to connection speed without additional coding. Thus, a viewer with a high-speed connection will hear the music as background to a voice that starts with it. A viewer with a dial up connection will hear the same music as lead in to the same voice that, because of connection speed, starts six seconds after the music.

Alternative embodiments include the same basic method of using code accompanying the web page to play two sound files triggered in response to the same event. One alternative is to embed a single player to play the two files in sequence instead of using two players. Another alternative is to pre-load a small number of short, generalized voice lead in files instead of MIDI music files. Alternatives may also include code that selects or avoids the use of the lead in file based on the connection speed. For example, if the connection speed is fast enough, the narrative voice could be played without a separate lead in file.

What is claimed is:

1. A method of providing quick and appropriate response to a single event such as an operator action in an interactive network such as the Internet by instructing a computer to play two audio files.

2. In a method of claim 1 where the operator action is a mouse movement over a location on a web page.

3. In a method of claim 1 where the instructions are in the form of code executed by a browser program.

4. In a method of claim 1 where the instructions request accompanies a web page.

5. In a method of claim 1 where one of the media files played is a MIDI file.

6. In a method of claim 1 where one of the media files played is a short file.

7. A document containing code which instructs a computer to play two audio files in response to a single event such as an operator action in an interactive network such as the Internet.

8. A document in claim 8 that further instructs the computer to play in two simultaneous instances of media player software.

9. A method of providing quick and appropriate response to a single event such as an operator action in an interactive network such as the Internet by instructing a computer to play two audio files by simultaneously initiating two instances of media player software.

10. In a method of claim 9 where the operator action is a mouse movement over a location on a web page.

11. In a method of claim 9 where the instructions are in the form of code executed by a browser program.

12. In a method of claim 9 where the instructions request accompanies a web page.

13. In a method of claim 9 where one of the media files played is a MIDI file.

14. In a method of claim 9 where one of the media files played is a short file.
